(19) United States
(12) Patent Application Publication
(10) Pub. No.: US 2014/0232502 A1
(43) Pub. Date: Aug. 21, 2014

(54) FLEXIBLE SUBSTRATE INDUCTIVE APPARATUS AND METHODS

(71) Applicant: PULSE ELECTRONICS, INC., San Diego, CA (US)

(72) Inventors: Aurelio Gutierrez, Bonita, CA (US); Dan Kuehler, San Diego, CA (US); Mohammad Saboori, San Diego, CA (US); Hamlet Abedmanoore, San Diego, CA (US)

(21) Appl. No.: 13/801,967

(22) Filed: Mar. 13, 2013

Related U.S. Application Data
(60) Provisional application No. 61/767,706, filed on Feb. 21, 2013.

(51) Int. Cl. H01F 5/00; H01F 41/04

(52) U.S. Cl. CPC H01F 5/003; H01F 41/041
USPC 336/200; 29/605

(57) ABSTRACT

Flexible substrate inductive apparatus and methods for manufacturing, and utilizing, the same. In one embodiment, the flexible substrate inductive device includes a square shaped ferrite core having four (4) portions of flexible substrate disposed thereon. The disposal of the conductive traces onto the substrate utilizes highly controlled manufacturing processes such that the characteristics of the device, including the spacing and pitch of the windings, can be accurately controlled. The accurate placement of these conductive traces produces an inductive device with highly consistent performance capabilities as compared with traditional wire wound inductive devices. In addition to the performance capabilities provided via the use of flexible substrates utilizing highly automated processes, the flexible substrate inductive devices disclosed herein minimize/eliminate errors associated with traditional wire wound inductive devices.

### PRIORITY

This application claims the benefit of priority to co-owned U.S. Provisional Patent Application Ser. No. 61/767,706 of the same title filed Feb. 21, 2013, the contents of which are incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

1. Technological Field

The present disclosure relates generally to inductive devices and more particularly in one exemplary aspect to flexible inductive apparatus having various desirable electrical and/or mechanical properties, and methods of utilizing and manufacturing the same.

2. Description of Related Technology

A myriad of different configurations of inductors and inductive devices are known in the prior art. One common approach to the manufacture of efficient inductors and inductive devices is the use of a magnetically permeable closed-shaped core. Closed-shaped cores are very efficient at maintaining the magnetic flux of an inductive device constrained within the core itself. Typically these cores (toroidal or not) are wound with one or more magnet wire windings, thereby forming an inductor or other types of inductive devices (such as e.g., transformers).

Prior art inductors and inductive devices are exemplified in a wide variety of shapes and manufacturing configurations. See for example, U.S. Pat. No. 3,614,554 to Shield, et al. issued Oct. 19, 1971 and entitled “Miniaturized Thin Film Inductors for use in Integrated Circuits”; U.S. Pat. No. 4,253,231 to Nouet issued Mar. 3, 1981 and entitled “Method of making an inductive circuit incorporated in a planar circuit support member”; U.S. Pat. No. 4,547,961 to Bokil, et al. issued Oct. 22, 1985 and entitled “Method of manufacture of miniaturized transformer”; U.S. Pat. No. 4,847,986 to Meinel issued Jul. 18, 1989 and entitled “Method of making square toroid transformer for hybrid integrated circuit”; U.S. Pat. No. 5,055,816 to Altman, et al. issued Oct. 8, 1991 and entitled “Method for fabricating an electronic device”; U.S. Pat. No. 5,126,714 to Johnson issued Jun. 30, 1992 and entitled “Integrated circuit transformer”; U.S. Pat. No. 5,257,000 to Billings, et al. issued Oct. 26, 1993 and entitled “Circuit elements dependent on core inductance and fabrication thereof”; U.S. Pat. No. 5,487,214 to Walters issued Jan. 30, 1996 and entitled “Method of making a monolithic magnetic device with printed circuit interconnections”; U.S. Pat. No. 5,781,091 to Krone, et al. issued Jul. 14, 1998 and entitled “Electronic inductive device and method for manufacturing”; U.S. Pat. No. 6,440,750 to Feygenson, et al. issued Aug. 27, 2002 and entitled “Method of making integrated circuit having a micromagnetic device”; U.S. Pat. No. 6,445,271 to Johnson issued Sep. 3, 2002 and entitled “Three-dimensional micro-coils in planar substrates”; U.S. Patent Publication No. 20060176139 to Pleskach; et al. published Aug. 10, 2006 and entitled “Embedded toroidal inductor”; U.S. Patent Publication No. 20060290457 to Lee; et al. published Dec. 28, 2006 and entitled “Inductor embedded in substrate, manufacturing method thereof, micro device package, and manufacturing method of cap for micro device package”; U.S. Patent Publication No. 20070001796 to Waffenschmidt; et al. published Jan. 4, 2007 and entitled “Printed circuit board with integrated inductor”; and U.S. Patent Publication No. 20070216510 to Jeong; et al. published Sep. 20, 2007 and entitled “Inductor and method of forming the same”, the contents of each of the foregoing incorporated herein by reference in its entirety. Despite the automation of key tasks in traditional wire-wound inductive devices, certain tasks still require human labor resulting in increased costs due in part to ever-increasing labor rates. For example, wires must be laid out, cut, and carefully terminated. Each of these processes has been heretofore impossible to implement using automated processes.

Accordingly, despite the broad variety of prior art inductor configurations, there is a salient need for inductive devices that are both; (1) low in cost to manufacture; and (2) offer improved and more consistent electrical performance over prior art inductive devices. Ideally such a solution would not only offer very low manufacturing cost and improved electrical performance for the inductor or inductive device, but also provide greater consistency between devices manufactured in mass production; i.e., by increasing consistency and reliability of performance by, for example, limiting opportunities for manufacturing errors of the device. It would also be desirable to utilize approach that does not suffer the disabilities outlined above with respect to turning/spinning rods.

### SUMMARY

In a first aspect, a flexible substrate inductive apparatus is disclosed. In one embodiment, the flexible substrate inductive apparatus comprises a substrate having a plurality of traces printed thereon, the substrate being flexible so as to enable the plurality of traces to act as windings that are disposed about a ferrite core.

In an alternative embodiment, the flexible substrate inductive device comprises a flexible printed substrate inductive device. The flexible printed substrate inductive device includes a flexible polymer film having a plurality of conductive traces disposed thereon; and a ferrous core. The flexible polymer film is shaped so that the plurality of conductive traces forms one or more electrically conductive windings. Furthermore, the ferrous core is disposed such that its use in combination with the one or more windings forms the inductive device.

In a second aspect, electronic apparatus that utilize the aforementioned flexible substrate inductive apparatus is disclosed. In one embodiment, the electronic apparatus comprises an integrated connector module, and the flexible substrate inductive apparatus contained therein offers electrical isolation between the line side and chip side of the integrated connector module.

In a variant, the integrated connector module includes a connector housing having a substrate inductive device disposed therein. The substrate inductive device includes a flexible material having a plurality of conductive traces printed thereon; and a ferrous core. The flexible material is configured so that the plurality of conductive traces forms one or more electrically conductive windings such that the flexible material in combination with the ferrous core forms the substrate inductive device.

In a third aspect, methods of manufacturing the aforementioned flexible substrate inductive apparatus are disclosed. In one embodiment, method includes printing one or more conductive windings onto a flexible substrate; wrapping the flexible substrate around a ferrous core; and terminating a plurality of ends of the flexible substrate to a base portion of the flexible substrate so as to form the flexible printed substrate inductive device.

In a fourth aspect, methods of manufacturing the aforementioned electronic apparatus that utilizes a flexible substrate inductive apparatus are disclosed.

In a fifth aspect, methods of using the aforementioned flexible substrate inductive apparatus are disclosed.

In a sixth aspect, a flexible substrate adapted for use on e.g., an inductive device core, is disclosed. In one embodiment, the substrate includes a plurality of traces, and is shaped so as to permit formation of the substrate around the core so as to enable magnetic induction.

### BRIEF DESCRIPTION OF THE DRAWINGS

The features, objectives, and advantages of the present disclosure will become more apparent from the detailed description set forth below when taken in conjunction with the drawings, wherein:

FIG. 1A is a perspective view illustrating a first embodiment of a flexible substrate inductive device in accordance with the principles of the present disclosure.

FIG. 1B is a perspective view illustrating the flexible substrate, prior to being formed around a core, illustrated in FIG. 1A.

FIG. 1C is a perspective view illustrating the flexible substrate inductive device of FIG. 1A with the core removed from view.

FIG. 1D is a perspective view illustrating the underside of the flexible substrate inductive device of FIG. 1A.

FIG. 1E is a cross sectional view taken along lines 1E-1E illustrating the construction of the flexible substrate inductive device of FIG. 1A.

FIG. 2 is a process flow diagram illustrating a first exemplary embodiment of a method for manufacturing a flexible substrate inductive device in accordance with the principles of the present disclosure.

All Figures disclosed herein are © Copyright 2013 Pulse Electronics, Inc. All rights reserved.

### DETAILED DESCRIPTION OF EXEMPLARY EMBODIMENTS

Reference is now made to the drawings wherein like numerals refer to like parts throughout.

As used herein, the term “closed-shape” refers without limitation to, in the context of magnetically permeable cores, cores having a closed or substantially closed (i.e. gapped) magnetic path about the core. Closed-shape refers to, for example, square, rectangular, round, oval, hexagonal, octagonal, etc. core shapes.

As used herein, the terms “electrical component” and “electronic component” are used interchangeably and refer to components adapted to provide some electrical and/or signal conditioning function, including without limitation inductive reactors (“choke coils”), transformers, filters, transistors, gapped core toroids, inductors (coupled or otherwise), capacitors, resistors, operational amplifiers, and diodes, whether discrete components or integrated circuits, whether alone or in combination.

As used herein, the term “etching” or “engraving” refers without limitation to the process of removing material via the application of light energy (e.g. a laser) or via a chemical reduction process. Additionally, any etching process of print thin films previously deposited and/or the underlying substrate itself includes wet etching, and dry etching, among others. Etching can also be referred to as photo chemical milling, metal etching, chemical machining, or photo fabrication whether one sided or two sided etching. Additionally, etching can apply to either the positive or negative image, or both.

As used herein, the term “magnetically permeable” refers to any number of materials commonly used for forming inductive cores or similar components, including without limitation various formulations made from ferrite.

As used herein, the term “printing” refers without limitation to both printing using traditional print fluids as well as processes that include: digital printing such as thermal inkjet, piezo inkjet, micro piezo inkjet, bubble jet; analog printing technologies such as screen printing, gravure printing, flexo printing, engraving printing, pad printing, rotary printing, rotary screen printing, stencil printing and others; aerosol jetting including the use of a mist generator that atomizes a source material where the aerosol stream can then be refined and deposited (e.g. Optomec). Variations include maskless mesoscale materials deposition; fluid and material dispensing systems using auger, head over valve, piezo, valve, needle, screw, cavity, conformal coaters, and pumps. Printing also refers to micro contact printing, nano-imprint lithography, etching/engraving including on conductive foils, Laser Direct Structuring (LDS), and spray and stencil techniques whether one sided or two sided printing. Additionally, printing can refer to the separate process where the laser engraves, marks, or etches a substrate including LDS where a substrate is molded using an LDS-grade resin that can be laser activated (e.g. LPKF). Additionally, printing can apply to either the positive or negative image or both.

As used herein, the term “print fluids” refers without limitation to conductors, semiconductors, dielectrics, or insulators whether of an organic or inorganic nature. Print fluids can take the form of liquid, for solution, dispersion or suspension. For example, print fluids can be made from electrically conductive materials or particles with a metallic base (e.g. silver, copper, gold, aluminum, alloys and/or mixtures of these elements, micron or nano particles of these elements, and any other elements). Such print fluids include inks, pastes, polymers, or printable pastes and/or inks based on conductive polymers, conductive oxides, like iron oxide, ITO or aluminum zinc oxide, carbon nanotubes or graphene.

As used here, the term “seed printing” refers without limitation to conductive inks that can be used in the printing of seed layers for electroplating processes. Upon printing of a seed layer, an electroplating process (such as, for example, copper) can be deposited onto the printed layer.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a PCB or other substrate).

### Overview

The present disclosure provides, inter alia, improved substrate inductive apparatus, and methods for manufacturing and utilizing the same.

In one exemplary embodiment, a flexible substrate inductive device is shown and described in detail. The flexible substrate inductive device includes a shaped (e.g., square, rectangular, round, oval, hexagonal, octagonal, etc.) ferrite core having multiple portions (e.g. four (4)) of flexible substrate disposed thereon. The disposal of the conductive traces onto the substrate in the exemplary embodiment utilizes a high-precision manufacturing processes such that the characteristics of the device, including the spacing and pitch of the windings, can be accurately controlled. The accurate placement and control of these conductive traces produces an inductive device with highly consistent performance capabilities from device-to-device, as compared with traditional wire wound inductive devices. In addition to the performance advantages provided via the use of flexible substrates utilizing highly automated processes, as compared to prior art wire wound inductive devices, errors associated with traditional wire wound inductive devices are also minimized/eliminated.

In alternative embodiments, the flexible substrate inductive device contains a core having other polygonal shapes, such as hexagonal, octagonal, etc. with accompanying flexible substrate portions positioned at sixty degrees (60°) or forty-five degrees (45°), respectively. These and other variations would be readily apparent to one of ordinary skill given the present disclosure.

The surface of the exemplary implementation of the flexible substrate includes a number of conductive traces disposed upon an insulating body that, when the interconnections are properly aligned around the underlying core, forms a continuous set of windings. These interconnections can be completed using a plastic carrier with metal pins. Alternatively, the use of ultrasonic welding, heat staking or a eutectic solder may also be used to create the connection by bridging these interface points.

In one exemplary embodiment, the underside of the formed flexible substrate inductive device includes external interface points that are utilized to electrically and mechanically join the substrate inductive device to an external substrate, such as the printed circuit board utilized within, for example, an integrated connector module.

Methods of using and manufacturing the aforementioned flexible substrate inductive devices are also disclosed.

### Exemplary Embodiments

Detailed descriptions of the various embodiments and variants of the apparatus and methods of the present disclosure are now provided. It will be appreciated that while the following discussion is cast in terms of a transformer, the present disclosure is not so limited, and is in fact equally applicable to other inductive devices including, without limitation, inductors, choke coils, and the like. These and other applications would be readily apparent to one of ordinary skill given the present disclosure.

Additionally, while primarily discussed in the context of printing on a flexible substrate for fabrication of mechanically flexible electronics, it is appreciated that printing can also be performed on rigid substrates like glass and silicon, plastic or metals like ferrite as well. For example, a laser direct structuring (“LDS”) process can be applied to a three-dimensional molded (i.e. over-molded or injection molded) plastic substrate and a core can be subsequently inserted into this rigid structure. These flexible or rigid substrates may comprise, for example, polyethylene terephthalate (“PET”), polyethylene naphthalate (“PEN”), polycarbonate (“PC”), acrylonitrile butadiene styrene (“ABS”), as well as any high-density polyethylene (“HDPE”) and low-density polyethylene (“LDPE”) plastics.

### Inductive Device—

Mass customization is a new frontier in manufacturing industries. Shorter production runs driven by mass customization and resultant smaller lot sizes for traditional wire wound inductive devices have traditionally required extensive setup and overhead costs (e.g. adjusting flyers, shields, guiding elements, etc.). It is recognized herein that is it not possible to face future market requirements such as small lot sizes or high product flexibility, with current manufacturing approaches. The present disclosure provides, inter aha, a new approach for an improved inductive device that allows for accurate wire placement, wire width, and wire gaps by using, for example, generalized printing techniques. These windings can be digitally constructed, with each layout being unique (down to a single manufacturing unit if desired). For example, the use of flexible computer-aided printing systems in manufacturing can be used consistent with the present disclosure to produce custom layouts item-by-item. These systems have advantages or synergies when combined with low costs resulting from mass produced planar windings, and with the flexibility of individual customization. Consequently, the number of manufacturing steps can be reduced, and enhanced flexibility around job design specifications can be realized. Current trends in production technology are challenging for conventional winding methods. Different automobiles, for example, can require different coils sizes. Different network cards can require different winding geometries as bandwidth varies. In one salient aspect of this innovation, a tremendous increase in variety and customization without a corresponding increase in costs is advantageously provided.

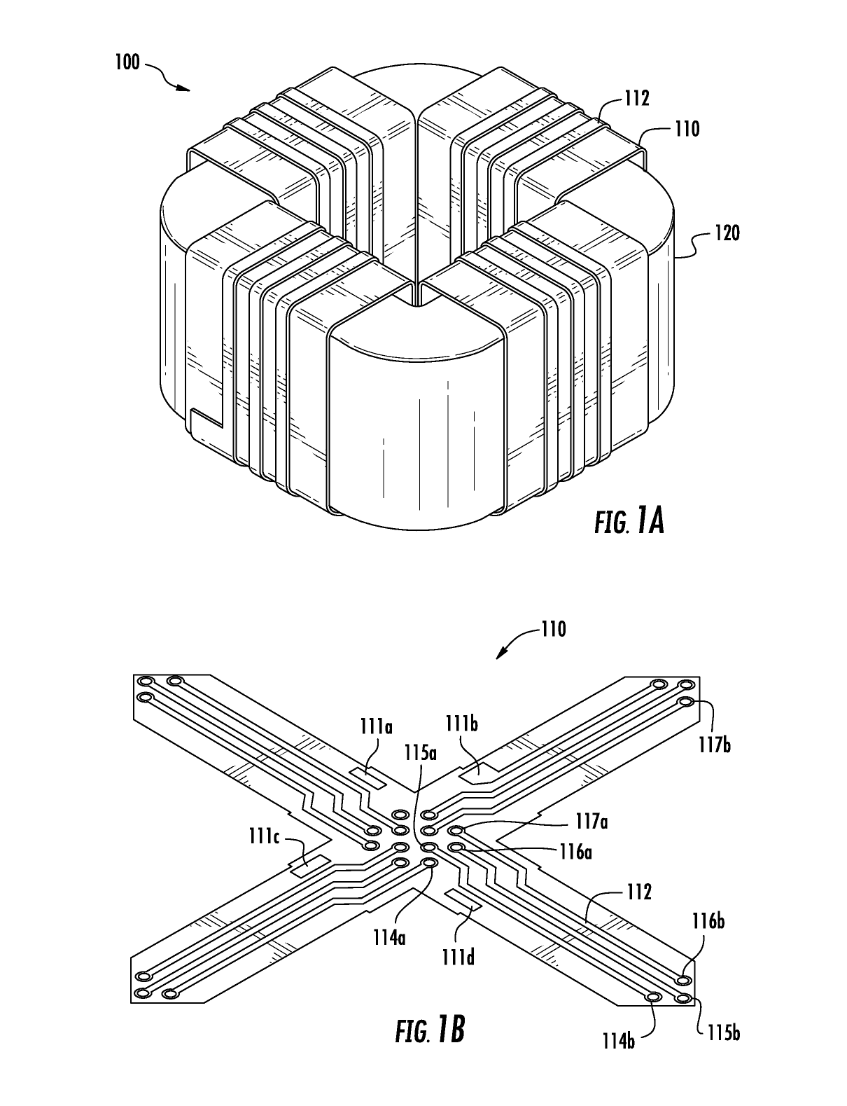

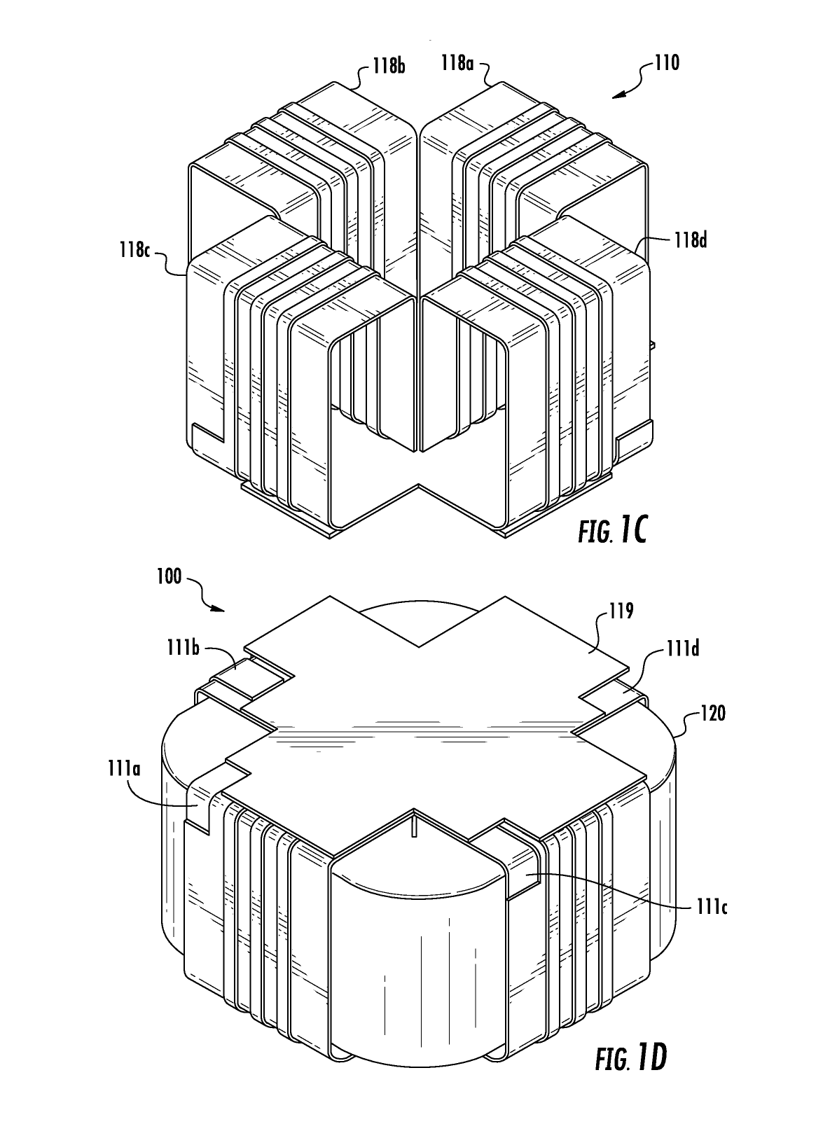

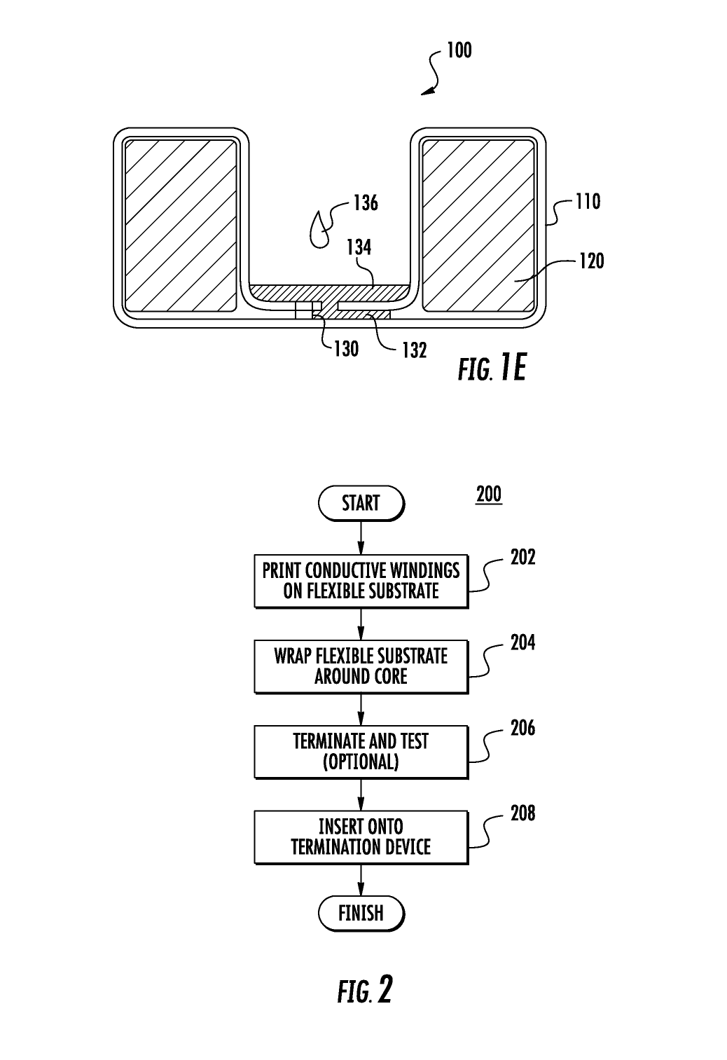

Referring now to FIG. 1A, one exemplary embodiment of a flexible substrate inductive device 100 is shown and described in detail. The flexible substrate inductive device of FIG. 1A includes, in the illustrated embodiment, a generally square-shaped ferrite core 120 having four (4) portions of flexible substrate 110 disposed thereon. The flexible substrate is comprised of, in one embodiment, a high-performance polymer material, such as polyimide, polyester, polyethylene napthalate, or polyetherimide among others. The use of such a flexible substrate for forming the conductive traces 112 of the flexible substrate inductive device is advantageous for a number of reasons, including the following. First, the use of a flexible substrate with printed winding allows for the accurate and repeatable placement of the traces themselves. For example, the conductive traces 112 are formed on the flexible substrate utilizing well known printed circuit board (PCB) processing printing/etching techniques of the type known in the art.

Regardless of the specific method chosen, the disposal of the conductive traces onto the substrate utilizes highly controlled manufacturing processes such that the characteristics of the device, including the spacing and pitch of the windings, can be accurately controlled. The accurate placement of these conductive traces produces an inductive device with highly consistent performance capabilities as compared with traditional wire wound inductive devices (the latter which can have, inter alia, significant variations in the disposition or placement of windings around the core form device-to-device). In addition to the performance capabilities provided via the use of flexible substrates utilizing highly automated processes (as compared to prior art wire wound inductive devices), errors associated with traditional wire wound inductive devices are minimized/eliminated. Ultimately these automated processes result in, inter alia, reduced production costs and improved performance accuracy. In the context of a printed flexible substrate, print insulation techniques such as the deposition of isolating and flexible coatings can be applied to improve upon the isolation properties of the underlying printed substrate, and for resistance to corrosion or other deleterious effects. In one embodiment, the isolating cover coat also comprises a printable paste and/or ink and can, for example, be added as a sheet of film between different conductive printing layers thereby operating as a dielectric.

Referring again to FIG. 1A, although a square shaped core 120 having four (4) flexible substrate portions positioned every ninety degrees (90°) is shown, it is recognized that such a configuration can be readily modified or substituted. For example, the core can be rectangular (versus square), or can have other polygonal shapes as well, including hexagonal, octagonal, etc. with accompanying flexible substrate portions positioned at sixty degrees (60°) or forty-five degrees) (45°, respectively. These and other variations would be readily apparent to one of ordinary skill given the present disclosure. Alternatively, the core need not be a polygon shape at all. For example, it is appreciated that certain conductive trace configurations can be utilized on flexible substrates adapted for use on a closed-shaped core of the type well known in the electronic arts, or even a polygon approximating a closed-shaped (e.g., one with 12 multifaceted sides).

Referring now to FIG. 1B, the illustrated embodiment of the flexible substrate 110 contained within FIG. 1A is shown and described in detail. Specifically, the flexible substrate is shown in its planar form; i.e., prior to being formed for use with the core illustrated in, for example, FIG. 1A. The flexible substrate comprises a cross-like shape having four ends that are formed with a feature that forms a forty-five degree (45°) offset to each of the legs of the flexible substrate. This offset allows for the ends of each of the legs to come together without interfering with one another (see, for example, FIG. 1D). Again, it is appreciated that the specific shape of the ends of the flexible substrate is dependent on the shape of the core chosen, and the resultant number of ends disposed on the flexible substrate.

The surface of the flexible substrate includes a number of conductive traces disposed upon an insulating body that when properly aligned around the underlying core forms a continuous set of windings. For example, internal interface point 114a is configured to interface with an adjacent conductive trace at interface point 114b. These interconnections can be completed using a plastic carrier with metal pins. Alternatively, the use of ultrasonic welding, heat staking or a eutectic solder could also be used to create the connection by bridging these interface points. Furthermore, electrically connected to the interface point 114b is an internal interface point 115a. Internal interface point 115a is configured to interface with an outer interface point 115b. The outer interface point 115b is electrically connected to the internal interface point 116a via its respective conductive trace. The internal interface point 116a is configured to interface with another outer interface point 116b. The outer interface point 116b is electrically connected to an internal interface point 117a which is coupled to an external interface point 117b when the flexible substrate is ultimately formed about a core. Termination pads 111 resident on each of the legs of the substrate are used to couple the flexible substrate to an external printed circuit board. These termination pads can be used as the start, center tap and/or finish points of a transformer.

Referring now to FIG. 1C, the formed flexible substrate 110 is shown with the core removed from view. Specifically, and as can now be seen, the ends 118 of the flexible substrate have been formed so that the external interface points are now in electrical and physical communication with the internal interface points. FIG. 1D illustrates the underside of the formed flexible substrate of FIG. 1C so that the interface surface 119 of the flexible substrate 110 is now more readily visible. Specifically, the termination pads 111 resident on each leg of the flexible substrate are now readily visible. The interface surface 119 is, in the illustrated embodiment, covered with a thin insulating layer that electrically isolates the windings with the external printed circuit board to which the flexible substrate inductive device 100 is ultimately mounted, while leaving the termination pads available to be coupled to the external printed circuit board using, for example, a surface mount termination.

Referring again to FIG. 1D, the external interface points 111a, 111b, 111c, 111d are shown that are utilized in this embodiment to electrically and mechanically join the flexible substrate inductive device to an external substrate, such as the printed circuit boards described in co-owned and co-pending U.S. patent application Ser. No. 12/876,003 filed Sep. 3, 2010 and entitled “Substrate Inductive Devices and Methods”, the contents of which are incorporated herein by reference in its entirety. Accordingly, by including the flexible substrate inductive device with the connector assembly described above, alternative magnetics (such as that shown in FIGS. 1A-1E) can be included in the integrated connector module illustrated in the above-referenced U.S. patent application.

Referring now to FIG. 1E, a cross-section view of the flexible substrate inductive device 100 is illustrated. Specifically, FIG. 1E illustrates the construction of the flexible substrate 110 about the magnetically permeable core 120. The core is placed at the center of the flexible substrate and the ends of the flexible substrate are wrapped around the core. The outer interface point on the flexible substrate is then secured to the internal interface point at 130. In one embodiment, the outer and internal interface points are joined using a eutectic solder. In an alternative embodiment, the interface points are joined using a welding (e.g. laser, exothermic bonding, thermite, ultrasonic, arc, resistance, capacitive charge, etc.). In yet another alternative embodiment, the interface joints may be coupled via mechanical means such as by the addition of clips, the use of so-called “pogo” pins, springs and snap fits. These and other methods for electrically connecting the outer interface points with the internal interface points of the flexible substrate would be readily appreciated by one of ordinary skill given the present disclosure.

In addition to the securing of the external and internal interface points to one another, an insulating material 136 is also placed within the internal diameter of the core in order to render the flexible substrate inductive device more resistant to high-potential (“Hi-Pot”) electrical failures. The insulating material will advantageously comprise an epoxy having a high dielectric strength. The insulating material is applied external 134 to the interface point 130 of the flexible substrate 110. Alternatively, the insulating material can be applied both externally 134 and internally 132 of the flexible substrate 110. Such a configuration using the insulating material internally is useful when the space between adjacent interface points is small (e.g. a few mils).

### Methods of Manufacture—

Referring now to FIG. 2, one exemplary embodiment of the method for manufacturing 200 a flexible substrate inductive device is shown and described in detail. The flexible substrate is comprised of, in one embodiment, a high-performance polymer material, such as polyimide (“PI”), polyester, polyethylene napthalate (“PEN”), or polyetherimide. Flexible substrates can also be formed from paper cellulose pulp material or other wood-based materials as well.

At step 202, the conductive windings are printed onto the flexible substrate. These conductive windings may be printed using digital printing such as: (1) thermal inkjet; (2) piezo inkjet; (3) micro piezo inkjet; (4) bubble jet; or using analog printing technologies including: (1) screen printing; (2) gravure printing; (3) flexo printing; (4) engraving printing; (5) pad printing; (6) rotary printing; (7) rotary screen printing; (8) and stencil printing, among others. In addition, the conductive windings may be printed using a process known as aerosol jetting, wherein the mist generator that atomizes a source material that is refined and deposited (e.g. Optomec) is used. Other possible variations that may be used consistent with the disclosure include: (1) maskless mesoseale materials deposition; (2) fluid and material dispensing systems using e.g., auger, head over valve, piezo, valve, needle, screw, cavity, conformal coaters, and pumps.

Additionally, these processes can include: (1) micro contact printing; (2) nano-imprint lithography; (3) etching/engraving including on conductive foils; (4) Laser Direct Structuring (LDS); and (5) spray and stencil techniques. The etching and engraving process described above means removing material via light (e.g., laser) or via a chemical reduction process and include both wet etching and dry etching in appropriate circumstances. Moreover, printing or etching as described herein can apply to either the positive or negative image, or both. Etching can be also referred to as photo chemical milling, metal etching, chemical machining, or photo fabrication. Both one- and two-sided printing or etching is envisioned herein as well.

Conductive inks can also be used in the printing of seed layers for electroplating processes. Seed and grow technology generally involves printing a layer, and then electroplating another layer, such as a metal (copper, for example) onto the printed layer. Plating can then be used to decrease electronics cost.

Other print fluids that may be used consistent with the present disclosure include, but are not limited to, conductors, semiconductors, dielectrics, and insulators. Both organic and inorganic materials can be used. Printing fluids can take the form of a liquid, for solution, dispersion or suspension. The patterns can be made from electrically conductive materials or particles with a metallic base (e.g. silver, copper, gold, aluminum, alloys and/or mixtures of these elements, micron or nano particles of these elements, and any other suitable elements). These are printable in the general sense using inks, pastes, polymers, or printable pastes and/or inks based on conductive polymers, conductive oxides, like iron oxide, ITO or aluminum zinc oxide, carbon nanotubes or graphene.

In one exemplary embodiment, the flexible substrate is comprised of a polyimide film having a thickness ranging from about 0.0005 to 0.005 inches (0.5 to 5 mils). The use of polyimide is advantageous in that polyimide films have an excellent balance of electrical, mechanical and thermal properties. A metal foil (for example, copper) is then subsequently etched onto the underlying flexible substrate. These metal foils may include, for example, electrodeposited copper, rolled copper, and various other alloys. Base materials can include, but are not limited to steel, copper, nickel, and other various alloys.

While the use of a polyimide film is exemplary, other materials can readily be substituted for use with printing processes. These substrates suitable for printing can be formed of, for example, a paper cellulose pulp material or alternatively with a plastic material. The plastic material can include polyethylene terephthalate (“PET”), polyethylene naphthalate (“PEN”), polycarbonate (“PC”), acrylonitrile butadiene styrene (“ABS”), as well as any high-density polyethylene (“HDPE”) and low-density polyethylene (“LDPE”) rigid and semi-rigid plastics. When printing is chosen, the underlying substrate may also include pre- and post-treatment processes including thermal, infrared, corona, plasma (e.g. flame, chemical or atmospheric) or air ventilation using concentrations of gases such as oxygen, flame and etching, priming, or electrostatic treatment techniques. These treatments may also apply to conductive foils that have been printed or etched. Similar print treatments can provide additional mechanical or dielectric properties and include, without limitation, molding, over-molding or injection molding the substrates which are printed, insulated and/or plated.

Once printed using any of these pastes, inks or fluids, the underlying printed material must be cured. These printed pastes, inks or fluids can be cured using, for example, thermal oven based curing, infrared based curing, UV based curing, and microwave based curing, or may be flash cured using photonic curing systems. Additionally, these printed substrates can be cured using chemical curing or evaporation processes with the process of curing occurring under vacuum and/or thermal vacuum oven curing.

Subsequent to flexible substrate printing, the printed conductive traces often need to be cured. These pastes, inks or fluids can be cured using thermal oven based curing, infrared based curing, ultraviolet (UV) based curing, microwave based curing, or flash cured using photonic curing systems. Additionally, these printed conductive traces can be cured using chemical curing or evaporation processes. The process of curing can take place under vacuum, and/or using thermal vacuum oven curing.

At step 204, the flexible substrate is formed into its final inductive device form and one or more core portion(s) are inserted into the flexible substrate thereby forming the underlying flexible substrate inductive device. For example, in one embodiment, once printed the substrate can be shaped and/or rolled and/or folded with or without a cover coating in a three-dimensional (3D) shape. This is done via typical 3D forming techniques that include heat or pressure sufficient to cause the substrate to set in the desired 3D shape. Termination to the printed conductive material is done by integrating the carrier material with adhesives, welding (e.g., laser, exothermic bonding, thermite, ultrasonic, are, resistance, capacitive charge), clips, pogo pins, springs, snap fits, or soldering, or other joining methods. Additionally, certain areas may use pads applied by any of the printing methods described previously herein.

At step 206, the flexible substrate inductive device is optionally electrically tested in order to erasure that the device meets various electrical design parameters.

At step 208, the flexible substrate inductive device is inserted onto a termination device. In one embodiment, the termination device comprises an injection molded polymer header of the type known in the electronic arts. In an alternative embodiment, the flexible substrate inductive device is inserted into an integrated connector module thereby forming the underlying magnetic circuitry present within many of these integrated connector modules such as those described in, for example, U.S. Pat. No. 6,962,511 filed Sep. 18, 2002 and entitled “Advanced microelectronic connector assembly and method of manufacturing”; and U.S. Pat. No. 7,241,181 filed Jun. 28, 2005 and entitled “Universal connector assembly and method of manufacturing”, the contents of which were previously incorporated herein by reference in their entireties.

It will again be noted that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

What is claimed is:

1. A flexible printed substrate inductive device, comprising:
a flexible polymer film having a plurality of conductive traces disposed thereon; and
a ferrous core;
wherein the flexible polymer film is shaped so that the plurality of conductive traces forms one or more electrically conductive windings, the ferrous core disposed such that its use in combination with the one or more windings forms an inductive device.

2. The flexible printed substrate inductive device of claim 1, wherein the flexible polymer film comprises a base portion onto which the ferrous core is disposed and a plurality of ends extending from the base portion.

3. The flexible printed substrate inductive device of claim 2, wherein each of the plurality of ends has conductive traces disposed thereon comprised of a plurality of external interface points; and
wherein the base portion comprises a plurality of internal interface points.

4. The flexible printed substrate inductive device of claim 3, wherein each of the plurality of ends comprises an angular offset configured to allow each of the plurality of ends to come together without interfering with one another.

5. The flexible printed substrate inductive device of claim 3, wherein the plurality of external interface points are configured to interface with respective ones of the plurality of internal interface points thereby forming the one or more electrically conductive windings.

6. The flexible printed substrate inductive device of claim 5, further comprising one or more external mounting pads, the one or more external mounting pads configured to interface the flexible printed substrate inductive device to an external substrate.

7. The flexible printed substrate inductive device of claim 6, further comprising an insulating layer that electrically isolates the one or more electrically conductive windings from the external substrate.

8. The flexible printed substrate inductive device of claim 7, wherein the insulating layer is deposited using a print insulation technique.

9. The flexible printed substrate inductive device of claim 1, wherein the plurality of conductive traces are disposed such that the spacing and pitch of the plurality of conductive traces are accurately controlled.

10. The flexible printed substrate inductive device of claim 9, wherein the plurality of conductive traces disposed on the flexible polymer firm are printed thereon using a conductive ink.

11. An integrated connector module, comprising:
a connector housing having a substrate inductive device disposed therein, the substrate inductive device comprising:
a flexible material having a plurality of conductive traces printed thereon; and
a ferrous core;
wherein the flexible material is configured so that the plurality of conductive traces form one or more electrically conductive windings such that the flexible material in combination with the ferrous core forms the substrate inductive device.

12. The integrated connector module of claim 11, wherein the flexible material comprises a base portion onto which the ferrous core is disposed the flexible material further comprising a plurality of ends extending outward from the base portion.

13. The integrated connector module of claim 12, wherein each of the plurality of ends has conductive traces disposed thereon comprised of a plurality of external interface points; and
wherein the base portion comprises a plurality of internal interface points.

14. The integrated connector module of claim 13, wherein the plurality of external interface points are configured to be joined with respective ones of the plurality of internal interface points thereby forming the one or more electrically conductive windings.

15. The integrated connector module of claim 14, further comprising one or more external mounting pads, the one or more external mounting pads configured to interface the substrate inductive device to an external substrate that is disposed within the connector housing.

16. A method of manufacturing a flexible printed substrate inductive device, the method comprising:
printing one or more conductive windings onto a flexible substrate;
wrapping the flexible substrate around a ferrous core; and
terminating a plurality of ends of the flexible substrate to a base portion of the flexible substrate so as to form the flexible printed substrate inductive device.

17. The method of manufacturing the flexible printed substrate inductive device of claim 16, further comprising curing the one or more conductive windings after the one or more conductive windings have been printed onto the flexible substrate.

18. The method of manufacturing the flexible printed substrate inductive device of claim 17, further comprising depositing and insulating layer onto the flexible substrate using a print insulation technique.

19. The method of manufacturing the flexible printed substrate inductive device of claim 18, further comprising disposing the terminated flexible substrate onto an external substrate of an integrated connector module.

20. The method of manufacturing the flexible printed substrate inductive device of claim 19, further comprising disposing the external substrate inside the housing of the integrated connector module.
